(19) United States
(12) Patent Application Publication
(10) Pub. No.: US 2012/0137369 A1
(43) Pub. Date: May 31, 2012

(54) MOBILE TERMINAL WITH SECURITY FUNCTIONALITY AND METHOD OF IMPLEMENTING THE SAME

(75) Inventors: Soo Jung Shin, Seoul (KR); Hyo Sun Yoo, Seongnam (KR); Do Sung Ahn, Seongnam (KR)

(73) Assignee: INFOSEC CO., LTD., Seoul (KR)

(21) Appl. No.: 13/250,065

(22) Filed: Sep. 30, 2011

(30) Foreign Application Priority Data
Nov. 29, 2010 (KR) 2010-0119403
Nov. 29, 2010 (KR) 2010-0119404

(51) Int. Cl. G06F 21/00

(52) U.S. Cl. 726/25; 726/22

(57) ABSTRACT

Disclosed herein is a mobile terminal with security functionality and a method of implementing the mobile terminal. The mobile terminal with security functionality includes a storage unit, a first module, a second module, and a third module. The storage unit stores a list of risky function combinations which may cause security risks. The first module monitors functions included in an application to be installed or running in the mobile terminal. The second module assesses security vulnerabilities based on whether a combination of the monitored functions corresponds to a risky function combination and/or security attributes of the mobile terminal. The third module takes countermeasures when a security vulnerability has been found based on the assessment.

### CROSS-REFERENCE TO RELATED APPLICATION

This application claims under 35 U.S.C. §119(a) the benefit of Korean Application Nos. 10-2010-0119403 filed Nov. 29, 2010 and 10-2010-0119404 filed Nov. 29, 2010, the entire contents of which applications are incorporated herein by reference.

### BACKGROUND OF THE INVENTION

1. Field of the Invention

The present invention relates generally to a mobile terminal with security functionality and a method of implementing the mobile terminal, and, more particularly, to a mobile terminal with security functionality and a method of implementing the mobile terminal, which can prevent personal or important information stored in a mobile terminal from being leaked due to the combination of functions when an application to be installed or running includes a plurality of functions or a plurality of functions runs at the same time or due to the security status of the mobile terminal, thereby overcoming a security vulnerability problem.

2. Description of the Related Art

Currently, as services provided via mobile terminals, such as a mobile phone, are increasing in terms of quality and quantity, mobile platforms that provide execution environments for applications (a variety of types of digital content including application programs) independently of the hardware and Operating System (OS) of mobile terminals have appeared. Furthermore, with the development of mobile terminal- and wireless Internet-related technologies, a variety of applications and services based on mobile platforms have been developed, and large numbers of applications and services are competitively provided by many providers to meet users' various demands and preferences.

A mobile platform-based application or service is an application or wireless Internet service which can be executed on a mobile platform, and is generally downloaded from a download server via a wireless Internet network and installed in a mobile terminal. Users who access the Internet via wireless communication networks download necessary applications to mobile terminals so that they can use cyber shopping, banking transactions and other types of ordinary life-related information in mobile environments.

Meanwhile, a plurality of applications can be executed on a mobile terminal. In order to run a plurality of applications normally, it is necessary to manage a plurality of running applications, that is, to manage execution information such as the status of each application and the sequence of the execution of the applications. For a user to perform tasks, such as the playing of a game, the management of schedules and the management of memoranda, using a mobile terminal, corresponding applications should be provided, and the applications should enable updating and deletion to be performed.

Furthermore, since a plurality of communication interfaces is used, mobile terminals are exposed to a variety of communication networks, with the result that the importance of the security of mobile terminals is emphasized more and more. That is, since security status significantly varies depending on variations in environment, appropriate countermeasures in which current security status has been taken into consideration in real time should be taken to protect the security of information stored in mobile terminals.

In particular, the security vulnerabilities of applications installed in a mobile terminal differ depending on the types of applications. Accordingly, if a user does not take into consideration security status and runs an application having a security vulnerability, personal or important information stored in a mobile terminal may be leaked via an external device. For example, when a user runs a financial application in an environment having a security vulnerability and makes a banking transaction such as money transfer, there occurs the problem of personal financial information being leaked via an external device.

As described above, so far the security of applications distributed through markets is not verified, so that there is a security vulnerability, with the result that personal or important information stored in a mobile terminal may be leaked by running such an application without taking into consideration the security status of the mobile terminal.

As a result, there is a need for a scheme which is capable of improving the security of a mobile terminal while taking into consideration the combination of the functions of an application and/or the security status of the mobile terminal.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

Accordingly, the present invention has been made keeping in mind the above problems occurring in the prior art, and an object of the present invention is to provide a mobile terminal with security functionality and a method of implementing the mobile terminal, which can prevent personal or important information from being leaked due to the combination of functions when an application to be installed or running includes a plurality of functions or a plurality of functions run at the same time, thereby overcoming a security vulnerability problem.

Another object of the present invention is to provide a mobile terminal with security functionality and a method of implementing the mobile terminal, which can prevent personal or important information stored in the mobile terminal from being leaked while taking into consideration variable security status when an application runs.

Still another object of the present invention is to provide a mobile terminal with security functionality and a method of implementing the mobile terminal, which can appropriately deal with variations in security status because the severity of a security vulnerability varies depending on the type of application installed in the mobile terminal.

In order to accomplish the above objects, the present invention provides a mobile terminal with security functionality, including a storage unit for storing a list of risky function combinations which may cause security risks; a monitoring module for monitoring functions included in an application to be installed or running in the terminal; an assessment module for assessing security vulnerabilities based on whether a combination of the monitored functions corresponds to a risky function combination and/or security attributes of the terminal; and a countermeasure module for taking countermeasures when a security vulnerability has been found based on the assessment.

In order to accomplish the above objects, the present invention provides a mobile terminal with security functionality, including a storage unit for storing a list in which one or more applications which can run at each security level have been put; a monitoring module for monitoring security status; an assessment module for assessing a security level based on the monitoring; and a control module for, when the security level is set based on the assessment, performing control so that only one or more applications included in a corresponding list can run.

In order to accomplish the above objects, the present invention provides a method of implementing a mobile terminal with security functionality, including storing a list of risky function combinations which may cause security risks; monitoring functions included in an application to be installed or running in the terminal; assessing security vulnerabilities based on whether a combination of the monitored functions corresponds to a risky function combination and/or security attributes of the terminal; and taking countermeasures when a security vulnerability has been found based on the assessment.

In order to accomplish the above objects, the present invention provides a method of implementing a mobile terminal with security functionality, including storing a list in which one or more applications which can run at each security level have been put; monitoring security status; assessing a security level based on the monitoring; and performing control so that only one or more applications included in a corresponding list can run when the security level is set based on the assessment.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic diagram showing the configuration of a mobile terminal with security functionality according to an embodiment of the present invention;

FIG. 2 is a schematic diagram showing the configuration of a mobile terminal with security functionality according to another embodiment of the present invention;

FIG. 3 is a schematic flowchart showing a method of implementing a mobile terminal with security functionality according to an embodiment of the present invention;

FIG. 4 is a diagram showing a list of cases where the installation/running of applications is inappropriate in terms of security (abnormal types) and risky function combinations corresponding to the cases;

FIG. 5 is a schematic flowchart showing a method of implementing a mobile terminal with security functionality according to another embodiment of the present invention;

FIG. 6 is a diagram showing list A including lists 1, 2 and 3 corresponding to security levels;

FIG. 7 is a schematic flowchart showing a method of updating list A; and

FIG. 8 is a drawing showing list B of cases where the installation of applications is inappropriate in terms of security (abnormal types) and risky function combinations corresponding to the cases.

### DETAILED DESCRIPTION OF THE DISCLOSURE

Preferred embodiments of the present invention will be described in detail below with reference to the accompanying drawings. Reference now should be made to the drawings, in which the same reference numerals will be used throughout the different drawings to designate the same or similar components. Furthermore, if it is determined that detailed descriptions of related known components or functions may make the gist of the present invention obscure in the following description of the present invention, the detailed descriptions will be omitted.

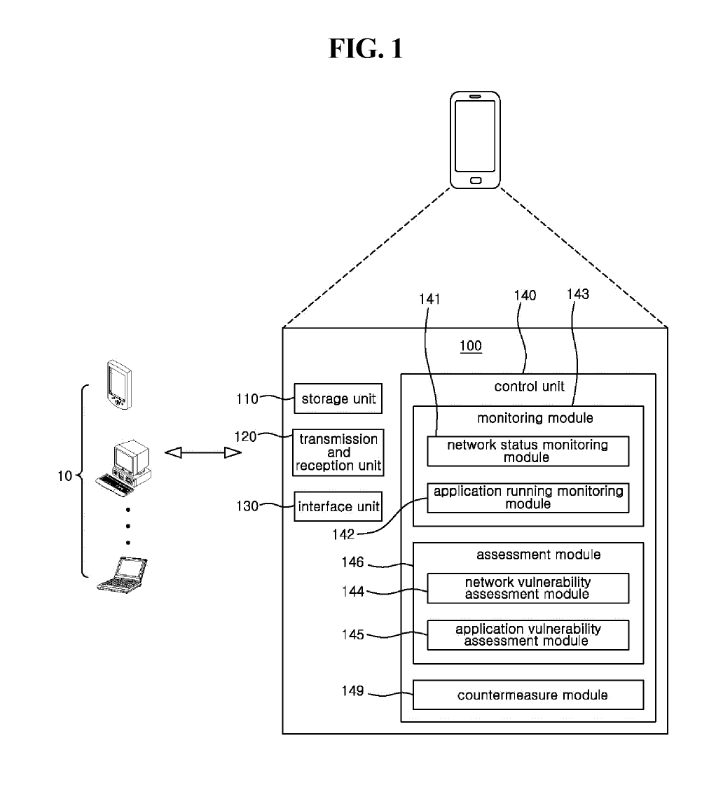

A mobile terminal with security functionality and a method of implementing the same according to embodiments of the present invention will be described in detail below with reference to FIGS. 1 to 8.

<Description of Configuration>

FIG. 1 is a schematic diagram showing the configuration of a mobile terminal 100 with security functionality according to an embodiment of the present invention.

Referring to FIG. 1, the mobile terminal 100 is a portable terminal that is small in size and has excellent mobility or portability, such as a mobile phone, a Personal Digital Assistant (PDA), a smart phone or a tablet Personal Computer (PC), and includes a storage unit 110, a transmission and reception unit 120, an interface unit 130 and a control unit 140.

The storage unit 110 stores a list of risky function combinations which may cause security risks and the overall data which is used to control the mobile terminal 100.

Here, the storage unit 110 may store the security attributes of the mobile terminal 100. The term “security attributes of a mobile terminal” refers to the security-related information of a mobile terminal itself, and includes the status of the permission of system administrator (root) authority, information about whether to allow an application which has not been distributed through a market to be installed, and the status of the locking of the mobile terminal. For example, in the case of a smart phone, OS-based security settings may be included therein. However, the security attributes of the mobile terminal 100 of the present invention are not limited only to those of the above-described embodiment, and include security attributes within the range in which those having ordinary knowledge in the corresponding field could easily make modifications.

The transmission and reception unit 120 functions to transmit and receive communication signals to and from the outside.

The interface unit 130 is provided such that a command can be input therethrough by a user. The interface unit 130 may be formed of a keypad and a display, or a touch screen in which both input and display can be performed using a single device without requiring a separate keypad.

The control unit 140 controls the mobile terminal 100 by outputting a control signal based on at least one of the command input to the interface unit 130, the list of risky function combinations stored in the storage unit 110, and the security attributes of the mobile terminal 100. For this purpose, the control unit 140 includes a monitoring module 143, an assessment module 146 and a countermeasure module 149.

The monitoring module 143 includes a network status monitoring module 141 for monitoring the status of the connection of a network and an application running status monitoring module 142 for monitoring functions included in an application (which is any of various types of digital content including an application program, and which includes an e-mail application, a messenger application, an Short Message Service (SMS) application, or a voice call application) to be installed or running in the mobile terminal 100.

The network status monitoring module 141 monitors the status of the connection of a network so as to prevent important information from being leaked by the attack of a misleading application, a virus, a worm or spyware over a network.

The application running status monitoring module 142 checks whether a designated application is running or stops, and checks the functions of an application installed in the mobile terminal 100.

The assessment module 146 includes a network vulnerability assessment module 144 for assessing the security vulnerability of a network using the monitoring of the network status monitoring module 141 and an application vulnerability assessment module 145 for accessing whether a function combination monitored by the application running status monitoring module 142 corresponds to a risky function combination and assesses security vulnerability based on at least one of the security attributes of the mobile terminal.

The network vulnerability assessment module 144 assesses the known security vulnerabilities of a wireless Local Area Network (LAN) and a general network. A method of assessing vulnerabilities includes a method of checking the match between a Service Set Identifier (SSID) and a MAC address and a method of checking whether Extended Service Set ID Broadcasting (ESSID) is possible, but is not limited thereto.

The application vulnerability assessment module 145 assesses security vulnerabilities based on whether the function combination of an application running or to be installed in the mobile terminal 100 corresponds to a risky function combination and based on the security attributes of the mobile terminal itself, and classifies the application as a secure application, a normal application or a risky application.

The countermeasure module 149 changes a security level to a level capable of dealing with the security vulnerability if the assessment of the network vulnerability assessment module 144 determines that a security vulnerability is present, and controls the operation of the application accordingly if the assessment of the application vulnerability assessment module 145 determines that a security vulnerability is present.

That is, if a security network vulnerability has been found, the countermeasure module 149 securely manages the important information stored in the storage unit 110 by blocking the access of an external device 10. Furthermore, if an application security vulnerability has been found, the countermeasure module 149 provides notification of the security vulnerability so that the operation of the application being run by a user or the installation of the application is stopped.

As described above, when a security vulnerability has been found by monitoring the status of the connection of the network or the status of the running of the application, countermeasures are taken accordingly, thereby achieving the effect of preventing personal or important information stored in the storage unit 110 from being leaked via the external device 10.

The assessment of the security vulnerability of an application and countermeasures against the vulnerability, which belong to security functionality, according to an embodiment of the present invention, will be described in detail below.

First, if an application includes various functions when a user installs the application in the mobile terminal 100, the mobile terminal 100 checks the functions included in the application. If a security vulnerability has been found, the mobile terminal 100 takes countermeasures accordingly.

That is, when the application is installed, the application running status monitoring module 142 checks functions included in an application to be installed based on information about functions to be used that is included in application installation data.

Thereafter, the application vulnerability assessment module 145 assesses security vulnerabilities based on whether a combination of functions included in an application to be installed in the mobile terminal 100 corresponds to a risky function combinations stored in the storage unit 110 and whether the security of the mobile terminal itself is vulnerable.

If a security vulnerability has been found by the application vulnerability assessment module 145, the countermeasure module 149 notifies the user of the security vulnerability, and performs control so that the installation of the application is stopped in response to the user's confirmation.

Here, a risky function combination refers to a combination of specific functions that has no security problem when the functions are separately performed but may cause a security problem when the functions are performed in combination, and is stored in the storage unit 110 in the form of a list. Meanwhile, the application installation data is the manifesto of the application, and includes metadata related to the application.

For example, if a combination of functions corresponds to a combination of a first function (communication, a camera, SMS, and . . . ), a second function (recording, location tracking, and . . . ) and a third function (Wi-Fi transmission, 3G transmission, Bluetooth transmission, and . . . ), it is determined that the former combination of functions is a risky function combination. Accordingly, the application running status monitoring module 142 checks the functions included in the application to be installed in the mobile terminal 100. The application vulnerability assessment module 145 assesses security vulnerabilities based on whether the combination of the functions included in the application corresponds to a risky function combination and based on the security attributes of the mobile terminal 100, and, if a security vulnerability has been found, the countermeasure module 149 outputs a message notifying the user of the security vulnerability and prompting the user not to install the application.

As described above, prior to the installation of an application in the mobile terminal 100, a security vulnerability can be assessed in advance. If a security vulnerability has been found, the user is notified of the security vulnerability and the installation of an application inappropriate in terms of security can be blocked in response to the user's command. As a result, the effect of improving security can be achieved.

Meanwhile, the assessment of the security vulnerability of an application and countermeasures against the vulnerability, which belong to security functionality, according to another embodiment of the present invention, will be described in detail below.

First, the application running status monitoring module 142 receives information about running functions from the Operating System (OS) of the mobile terminal 100.

Furthermore, the application vulnerability assessment module 145 assesses security vulnerabilities based on whether the combination of the functions running in the mobile terminal 100 corresponds to a risky function combination stored in the storage unit 110 and based on the security attributes of the mobile terminal 100.

If a security vulnerability has been found by the application vulnerability assessment module 145, the countermeasure module 149 notifies the user of the security vulnerability, and performs control so that an application running the functions is stopped in response to the user's confirmation.

In other words, when the user runs and uses an application in the mobile terminal 100, the application vulnerability assessment module 145 assesses security vulnerabilities based on whether the combination of functions included in the application corresponds to a risky function combination and based on the security attributes of the mobile terminal 100, and the countermeasure module 149 outputs a message prompting the user to stop the operation of the application if a security vulnerability has been found.

If the user runs and uses two or more applications in the mobile terminal 100, the application vulnerability assessment module 145 assesses security vulnerabilities based on whether the combination of the functions of the two or more applications corresponds to a risky function combination and/or based on the security attributes of the mobile terminals, and the countermeasure module 149 outputs a message prompting the use to stop the operation of at least one of the two or more applications if a security vulnerability has been found.

Then the user may read the message prompting the user to stop the operation of the application, determine whether to stop or continue the running of the application, and then output a command.

According to the present invention, security vulnerabilities can be assessed based on whether the combination of functions of at least one application running in the mobile terminal 100 corresponds to a risky function combination and based on the security attributes of the mobile terminal 100. If a security vulnerability has been found, the user can be notified of the security vulnerability and the user can stop the running of the application by inputting a command using the interface unit 130. Accordingly, inappropriate applications can be prevented from running, so that the effect of improving security, such as the blocking of the leaking of important information, can be achieved.

For reference, the user may change the basic settings of an application, that is, an update cycle, an alarm method and inspection record storage, may search risky function combinations, and may search inspection records related to an access control violation and an attempt to leak important information, using the mobile terminal 100.

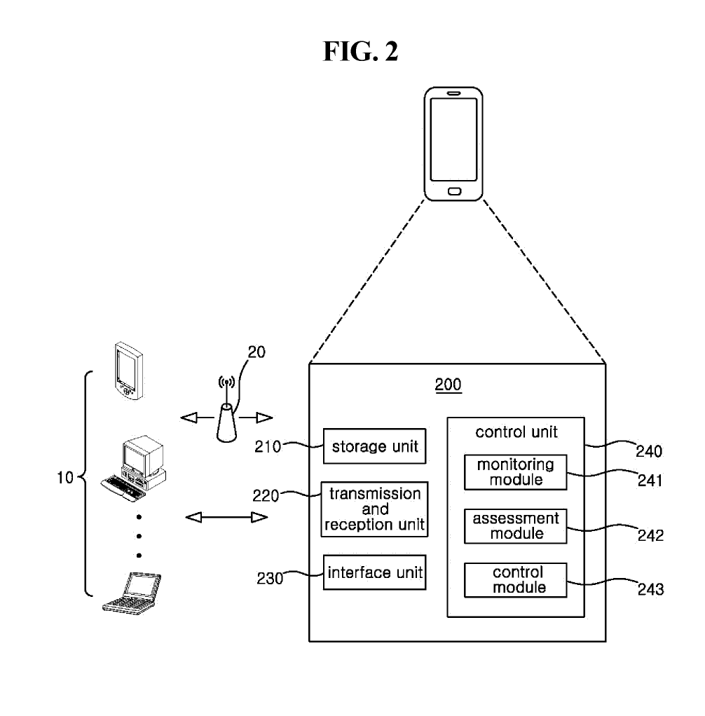

FIG. 2 is a schematic diagram showing the configuration of a mobile terminal 200 with security functionality according to another embodiment of the present invention.

Referring to FIG. 2, the mobile terminal 200 includes a storage unit 210, a transmission and reception unit 220, an interface unit 230, and a control unit 240.

The storage unit 210 stores lists (hereinafter referred to as “list A”) in which one or more applications (a variety of types of digital content including application programs, such as an e-mail application, a messenger application, an SMS application, and a voice call application) which can run at each security level of the mobile terminal 200 have been put and the overall data to be used for the control of the mobile terminal 200.

The transmission and reception unit 220 functions to transmit and receive communication signals to and from the outside.

The interface unit 230 is provided such that a command can be input therethrough by a user. The interface unit 230 may be formed of a keypad and a display, or a touch screen in which both input and display can be performed using a single device without requiring a separate keypad.

The control unit 240 outputs a control signal in compliance with the user's command input to the interface unit 230, and controls the mobile terminal 200 based on list A stored in the storage unit 210. For this purpose, the control unit 240 includes a monitoring module 241, an assessment module 242, and a control module 243.

The monitoring module 241 monitors security status based on information about the location of the mobile terminal 200, time information set in the mobile terminal 200 and/or the security of an Access Point (AP) 20 to which the mobile terminal 200 makes access. Here, the AP 20 is a device for transmitting radio waves so that the users of a wireless LAN located within a transmission distance can perform Internet, Wi-Fi or Bluetooth access and use the network. The AP 20 functions as a base station for a mobile phone or the hub of a wired network. The external device 10 is connected to the mobile terminal 200 via the AP 20.

The assessment module 242 assesses the security level of the mobile terminal 200 based on the monitoring of the monitoring module 241. In the present invention, the security levels of the mobile terminal 200 are classified into three levels depending on the seriousness of security status. The security levels are classified into security level 1 (highest security level), security level 2 (ordinary security level), and security level 3 (lowest security level) in descending order of security levels. Accordingly, list A stored in the storage unit 110 includes lists 1, 2 and 3 that correspond to security levels 1, 2 and 3, respectively.

The term “security level 1” refers to the highest security level at which status is currently risky in terms of security, the term “security level 2” refers to an ordinary security level, and the term “security level 3” refers to the lowest security level at which status is secure in terms of security. Each of lists 1, 2 and 3 defines one or more applications that can run at the corresponding security level, and defines at least one application which can run.

When the security level of the mobile terminal 200 is set by the assessment of the assessment module 242, the control module 243 performs control so that only one or more applications of list 1, 2 or 3 corresponding to the set security level can run. In order to perform the above control, the control module 243 automatically stops the running of an application that is not included in a list corresponding to the set security level.

At security level 1, it is possible to run applications defined in list A because the security level of the mobile terminal has been set to the highest level. At security level 2, it is possible to run applications defined in lists 2 and 3. At security level 3, it is possible to run only applications defined in list 3 because the security level of the mobile terminal has been set to the lowest level.

For example, when the security level of the mobile terminal 200 is set to security level 2 because the environment has changed, one or more applications defined in list 1 corresponding to security level 1 higher than security level 2 cannot be run, but only applications defined in list 2 corresponding to security level 2 and in list 3 corresponding to security level 3 lower than security level 2 can be run. If a financial application has been defined in list 1, a schedule management application has been defined in list 2, an alarm application has been defined in list 3 and the security level of the mobile terminal 100 has been currently set to security level 2, the schedule management and alarm applications can be run, but the security level is too low to run the financial application. Accordingly, if the security level of the mobile terminal is adjusted to security level 2 while the user is running and using the financial application, the running of the financial application is automatically stopped. Meanwhile, if an application not included in list A has been installed in the mobile terminal 200, the control module 243 outputs a message prompting the user to delete the application.

As described above, the mobile terminal 200 monitors security status, appropriately adjusts the security level in accordance with a variation in the variable security status, and performs control so that only one or more corresponding applications of lists 1, 2 and 3 can run, that is, so that the running of an application inappropriate to security status is forcibly stopped and a message prompting the user to delete an application vulnerable to security is provided, the effect of improving security, such as the blocking of the leaking of personal or important information (a directory, a call history, credit card information, and the like) via the external device 10.

Here, when the security level is set based on the assessment of the assessment module 242, the control module 243 may run a corresponding security solution (a firewall, an anti-virus program or the like). In accordance with the settings of the mobile terminal 200, control may be performed such that a security solution is run only at security level 1 or and a security solution is run only at security level 1 or 2. Alternatively, control may be performed such that a security solution is automatically run only when an application defined in list 1 or an application defined in list 1 or 2 is run, thereby further increasing security.

Meanwhile, in the present invention, security status is monitored based on the location information of the mobile terminal 200, time information set in the mobile terminal 200, and/or the security of the AP 20 to which the mobile terminal 200 makes access, and the security level is adjusted. That is, the mobile terminal 200 monitors security status and automatically recognizes a security region, the varying security level is applied depending on the location information (a house, a company, or a specific place) of a place where the mobile terminal 200 is located.

Alternative, when the user sets a specific period, for example, a work period, a vacation, after work, or a weekend/a holiday, in the mobile terminal 200, security status is monitored in the periods other than the specific period by monitoring the security status on the basis of the specific period, so that the security level is adjusted only when the above condition is met, with the result that only one or more appropriate applications can run in conformity with the adjusted security level.

Furthermore, when the mobile terminal 200 and the AP 20 communicate with each other, there are no security settings, such as user authentication, in the AP 20 and the mobile terminal 200 makes access, the security of the mobile terminal 200 may be set such that applications, other than designed applications, cannot run based on the security settings of the AP 20. In general, when there are no security settings in the AP 20, an intruder or a hacker can easily access the mobile terminal 200 via the external device 10, and therefore there is a high security risk. Accordingly, in the present invention, the security level of the mobile terminal 200 is appropriately set based on the security of the AP 20, thereby blocking the intrusion of an intruder.

Here, once an application has been installed in the mobile terminal 200, it is preferable to update list A so that list A includes the installed application, which will be described below.

First, the monitoring module 241 monitors functions included in an application to be installed in the mobile terminal 200.

The assessment module 242 functions to assess the security level based on whether the combination of the functions monitored by the monitoring module 241 corresponds to a risky function combination. The risky function combination is the combination of functions that do not pose a security problem when they are separately run but pose a security problem when they are run in combination. A list of risky function combinations which may cause security risks (hereinafter referred to as “list B”) is stored in the storage unit 210. The risky function combinations are classified into security levels 1, 2 and 3.

When the security level of the application is set based on the assessment of the assessment module 242, the control module 243 updates a list corresponding to the set security level (in the present invention, one of lists 1, 2 and 3) so that the corresponding list includes the application.

For example, if the combination of functions included in an application to be installed corresponds to the combination of function 1 (call, camera, SMS, and . . . ), function 2 (recording, location tracking, and . . . ) and function 3 (Wi-Fi transmission, 3G transmission, Bluetooth transmission, and . . . ), it is determined that the combination of the functions is a risky function combination. When this combination is defined as corresponding to security level 1, the control module 243 of the mobile terminal 200 updates list 1 so that list 1 includes the new application. Then only when the security level is set to security level 1, the mobile terminal 200 can run the new application. If it is determined that the combination of functions included in the new application does not correspond to a risky function combination, it is impossible to run the new application in all cases. Since security levels which differ depending on risky function combinations may vary according to setting criteria, they are not limited thereto.

Furthermore, the present invention may be configured such that using a black list and a white list, an application included in the white list can run at all security levels even when it is determined that the combination of the functions of the application corresponds to a risky function combination and an application included in the black list can run only at security level 1 regardless of risky function combinations. That is, the security level can be adjusted using at least one of list B, a black list and a white list.

As described above, prior to the installation of an application in the mobile terminal 200, functions included in the application are monitored, a security level is assessed based on whether the combination of the functions corresponds to a risky function combination, and a list corresponding to the set security level is updated to include the application, thereby achieving the effect of applying existing security levels even when a new application is installed.

<Description of Method>

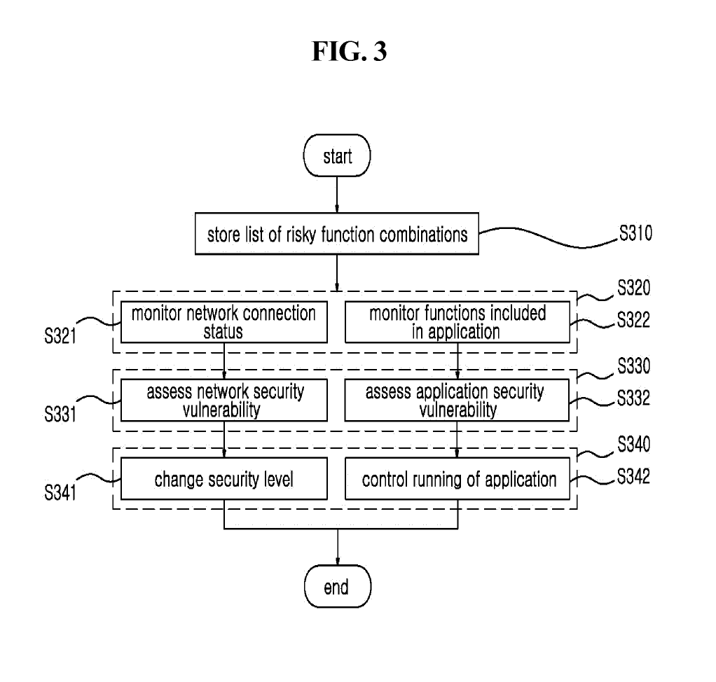

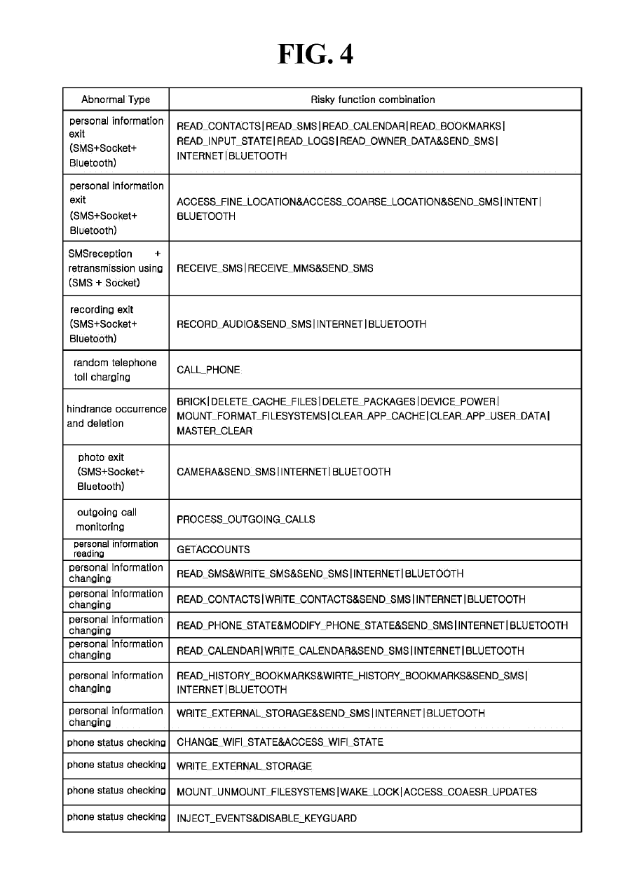

A method of implementing a mobile terminal with security functionality according to an embodiment of the present invention will be described in detail below with reference to the flowchart of FIG. 3 and the exemplary diagram of FIG. 4. For ease of description, sequential numbers will be assigned to respective steps.

1. Step S310 of Storing a List of Risky Function Combinations

A list of risky function combinations which may cause security risks is stored in the storage unit 110.

Here, the storage unit 110 may store the security attributes of the mobile terminal itself to be used to assess security vulnerabilities, for example, the status of the permission of administrator (root) authority, information about whether to allow an application which has not been distributed through a market to be installed, and the status of the locking of the terminal.

2. Step S320 of Monitoring Network Connection Status and Functions Included in the Application

Network connection status is monitored in order to prevent important information from being leaked by an attack over a network at step S321, and one or more functions included in an application to be installed or running in the mobile terminal 100 are monitored at step S322.

Here, the functions included in the application to be installed can be found based on information about the functions to be used that is included in application installation data. Furthermore, the application installation data is the manifesto of the application, and includes metadata related to the application.

3. Step S330 of Accessing Security Vulnerabilities

This step is the step of assessing security vulnerabilities based on the monitoring of step S320. The security vulnerability of a network is assessed by the monitoring of step S321 at step S331. At step S322, security vulnerabilities are assessed based on whether the combination of functions monitored corresponds to a risky function combination and also based on the security attributes of the mobile terminal 100 itself. That is, security vulnerability is assessed based on whether the combination of the functions of an application to be installed or running in the mobile terminal 100 corresponds to a risky function combination and the security attributes of the mobile terminal 100.

Here, the risky function combination is the combination of functions that do not pose a security problem when they are separately run but pose a security problem when they are run in combination, and is stored in the form of a list.

4. Step S340 of Taking Countermeasures

When a security vulnerability has been found at step S330, the operation of the mobile terminal 100 is controlled correspondingly.

First, if a security vulnerability of the network connection status is found at step S331, the security level is changed to a security level at which countermeasures can be taken against the security vulnerability, thereby preventing personal or important information from being leaked.

If the security vulnerability of the application is found at step S332, a message prompting the user to stop the installation of the application in the mobile terminal 100 is provided. Alternatively, a message asking whether to stop the running of the application running in the mobile terminal 100 is provided to the user via the interface unit 130.

In the following description, steps S322, S332 and S342 will be applied to various embodiments. In the present invention, if the combination of functions corresponds to one of the risky function combinations shown in FIG. 4, it is determined that the combination of functions is a risky function combination. However, the present invention is not limited thereto. FIG. 4 is a diagram showing a list of cases where the installation/running of applications is inappropriate in terms of security (abnormal types) and risky function combinations corresponding to the cases. For example, if a function combination corresponds to the combination of a first function (a call, a camera, SMS, and . . . ), a second function (recording, location tracking, and . . . ), and a third function (Wi-Fi transmission, 3G transmission, Bluetooth transmission, and . . . ), it is determined that the function combination is a risky function combination.

Steps S322, S332 and S342 are applied to an embodiment in the following description.

At step S322, when an application is installed, functions included in the application to be installed in the mobile terminal 100 are found based on information about functions to be used that is included in the application installation data.

At step S332, security vulnerabilities are assessed based on whether the combination of functions included in the application to be installed in the mobile terminal 100 corresponds to a risky function combination stored at step S310 and the security attributes of the mobile terminal 100.

If a security vulnerability has been found at step S332, notification of the found security vulnerability is provided to the user and control is performed such that the installation of the application is stopped in response to the user's confirmation at step S342. Here, when a security vulnerability-related message prompting the user to stop the installation of the application is provided to the user, the user inputs a command related to whether to continue to install the application or stop installing the application via the interface unit 130 of the mobile terminal 100 depending on his or her own decision.

According to this embodiment, prior to the installation of an application in the mobile terminal 100, the security vulnerabilities thereof can be assessed in advance, and, if a security vulnerability has been found, notification can be provided to the user and then the application inappropriate in terms of security, that is, the application having the security vulnerability due to the absence of the verification of security, can be prevented from being installed in response to the user's command, thereby achieving the effect of improving security.

Steps S322, S332 and S342 are applied to another embodiment in the following description.

At step S322, information about running functions is received from the OS of the mobile terminal 100. At step S332, security vulnerabilities are assessed based on whether the combination of the functions running in the mobile terminal 100 corresponds to the risky function combination and the security attributes of the mobile terminal.

If a security vulnerability has been found at step S332, notification of the security vulnerability is provided to the user and control is performed such that an application which runs the functions is stopped in response to the user's confirmation at step S342.

The above-described security vulnerability assessment and countermeasures are applied to the case where two or more functions are included in a single application and the combination of the two or more functions corresponds to a risky function combination, or the case where different functions are included in two or more different applications and the combination of the different functions corresponds to a risky function combination, along with or separately from the security attributes of the mobile terminal.

For example, if the user runs a recording application and then attempts to transmit recorded data in a Wi-Fi manner while a call application is running, the mobile terminal 100 may determine that the combination is a risky function combination and then output a message prompting the user to stop the running of at least one of the running applications. Accordingly, the user may read the message and stop the running of a specific application. Furthermore, when a combination of functions corresponds to the combination of a photo capture function, an SMS transmission function, an Internet function and a Bluetooth function in the list of risky function combinations shown in FIG. 4, the abnormal type thereof may be assessed as leaking out of photo, and notification may be provided to the user. Moreover, when the combination of the functions of the application corresponds to a risky function combination of FIG. 4, a prompting message is provided to the user. Although not shown in the drawing, other risky function combinations are possible, so that the risky function combinations are not limited to those shown in FIG. 4.

It is apparent that in the above cases, security vulnerabilities may be assessed by considering the security attributes of the mobile terminal as well as the risky function combinations.

According to this embodiment, if a security vulnerability attributable to the combination of the functions of an application running in the mobile terminal 100 or the security attributes of the mobile terminal is found, notification is provided to the user and the installation of an application inappropriate in terms of security can be blocked in response to the user's command, thereby overcoming a security vulnerability problem.

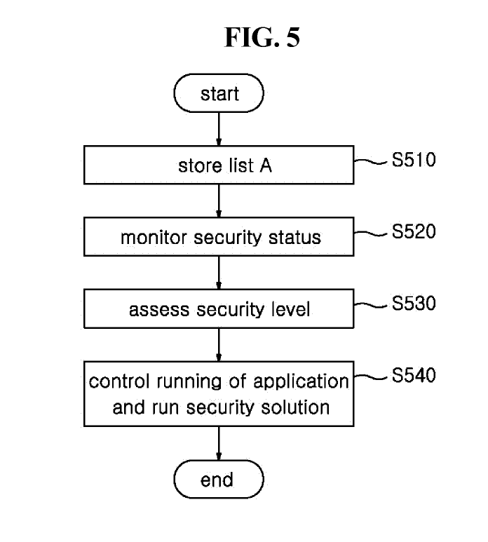

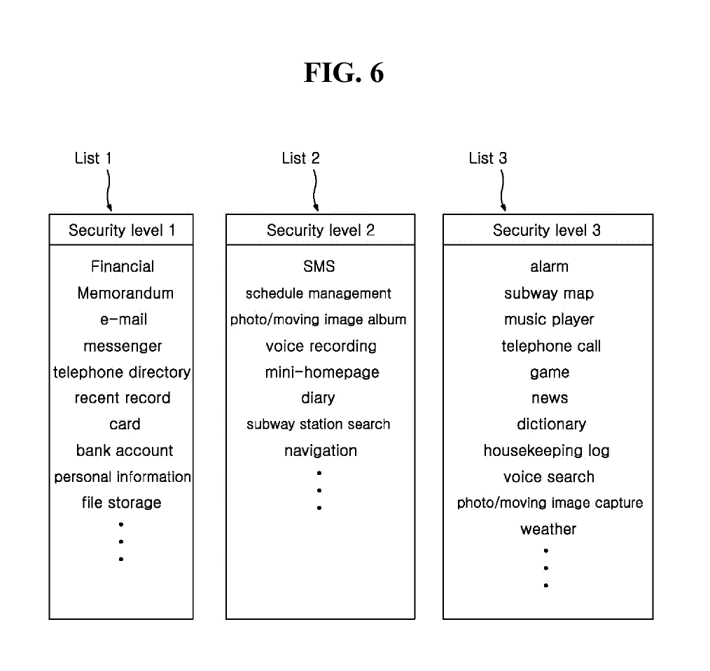

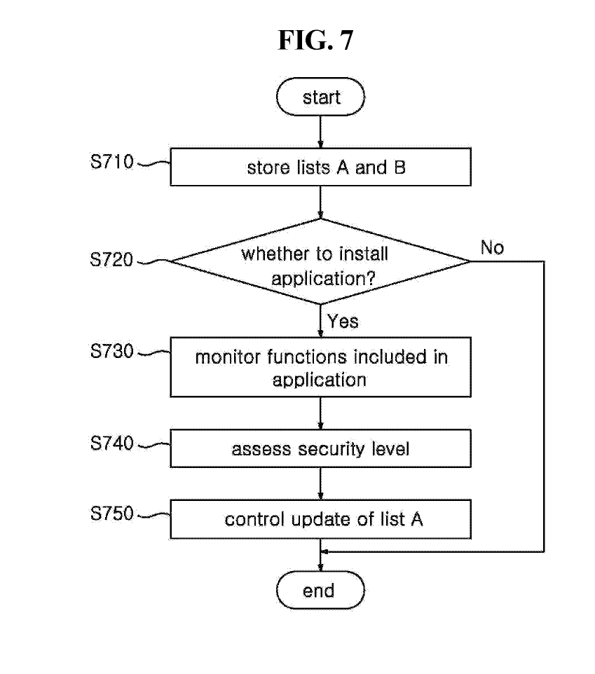

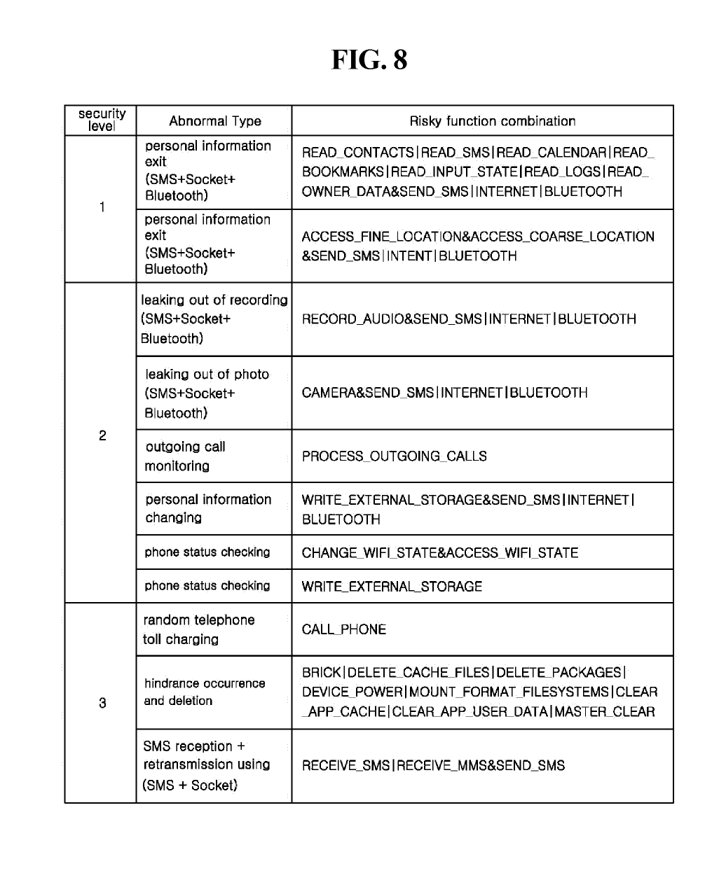

A method of implementing a mobile terminal with security functionality according to another embodiment of the present invention will be described in detail below with reference to the flowcharts of FIGS. 5 and 7 and the exemplary diagrams of FIGS. 6 and 8. For ease of description, sequential numbers will be assigned to respective steps.

1. Step S510 of Storing List A

List A (lists 1, 2 and 3) in which one or more applications which can run at each security level have been put, and the overall data to be used for the control of the mobile terminal 200 are stored.

Here, list A refers to a list in which one or more applications (a variety of types of digital content including an application program, including an e-mail application, a messenger application, an SMS application, and a voice call application) that can run at each security level of the mobile terminal 200 have been put.

2. Step S520 of Monitoring Security Status

Security status is monitored based on the location information of the mobile terminal 200, time information set in the mobile terminal 200, and/or the security of the AP.

3. Step S530 of Assessing Security Level

This step is the step of assessing the security level of the mobile terminal 200 based on the monitoring of the security status at step S520. The security levels of the mobile terminal 200 are classified into security level 1 (highest security level), security level 2 (ordinary security level) and security level 3 (lowest security level) depending on the seriousness of the security status. Lists 1, 2 and 3 correspond to security levels 1, 2 and 3, respectively. In list A, one or more applications that can run at each security level have been defined. Applications defined in lists 1, 2 and 3 can be run at security level 1, applications defined in lists 1 and 2 can run at security level 2, and only one or more applications defined in list 3 can run in security level 3. Referring to FIG. 6, financial, memorandum, e-mail, messenger, telephone directory, recent record, card, bank account, personal information and file storage applications corresponding to security level 1 have been defined in list 1, SMS, schedule management, photo/moving image album, voice recording, mini-homepage, diary, subway station search and navigation applications have been defined in list 2, and alarm, subway map, music player, telephone call, game, news, dictionary, housekeeping log, voice search, photo/moving image capture and weather applications have been defined in list 3. Since this definition may vary depending on the classification criteria, the definition of the present invention is not limited thereto. Meanwhile, the security level is adjusted in real time in light of variable security status at step S520, and therefore appropriate countermeasures can be taken.

4. Step S540 of Controlling the Running of an Application and Running a Security Solution

When the security level is set based on the assessment of step S530, control is performed such that only one or more applications corresponding to the set security level can run. The control module 243 of the mobile terminal 200 automatically stops the running of an application which is not included in a list corresponding to each security level based on list 1, 2 and 3.

For example, when the security level of the mobile terminal 200 is set to security level 2, only applications defined in lists 2 and 3 can run, the running of some other application, that is, an application defined in list 1, is automatically stopped or is not performed. If an application not included in list A has been installed in the mobile terminal 200, the control module 243 outputs a message prompting the user to delete the application not included in list A. Then the user may determine whether to delete the application or not, and input a corresponding command.

As described above, the mobile terminal 200 appropriately adjusts the security level in accordance with the variation in variable security status, and forcibly stops the running of an inappropriate application or provides a message prompting the user to delete an application vulnerable to security based on corresponding lists 1, 2 and/or 3, thereby preventing personal or important information from being leaked.

Here, since security status is monitored based on the location information of the mobile terminal 200, time information set in the mobile terminal 200, and/or the security of the AP at step S520, a security level varying depending on the location information of a place where the mobile terminal 200 is located (a house, a company, or a specific place) or specific time, so that the use of an inappropriate application can be blocked and only available applications can be provided. In particular, since the security level of the mobile terminal 200 can be set depending on whether the security of the AP 20 has been set, hacking attributable to an intrusion can be prevented in advance.

Furthermore, when the security level is set based on the assessment of step S530, a corresponding security solution is run at step S540. The running of the security solution may vary depending on the settings of the mobile terminal 200. If a specific security solution, such as a firewall or an anti-virus program, is run only while an application, which is defined in list 1, is running after the security level of the mobile terminal 200 has been set to security level 1, for example, if the mobile terminal 200 automatically runs a security solution while the user runs a financial application, personal financial information can be protected from hacking, so that the advantage of providing improved security can be achieved. Since the criteria of the running of the security solution may vary, they are not limited.

Meanwhile, it is preferable for list A to be updated to include an installed application when the application is installed in the mobile terminal 200. This will be described below with reference to FIGS. 7 and 8.

1. Step S710 of Storing Lists A and B

List A (lists 1, 2 and 3) in which one or more applications which can run at each security level have been put, a list B of risky function combinations which may cause security risks, and the overall data to be used for the control of the mobile terminal 200 are stored.

Here, list B includes combinations of functions each of which does not pose a security problem when the functions of each combination are performed separately but may cause a security problem when the functions are performed in combination.

2. Step S720 of Asking Whether to Install an Application or Not

When the user accesses T store or a market and installs a new application in the mobile terminal 200, the mobile terminal 200 outputs a message asking the user whether to install the application.

3. Step S730 of Monitoring Functions Included in the Application

When the user inputs a command to install the application, the monitoring module 241 monitors functions included in the application to be installed.

Here, the monitoring module 241 can find the functions included in the application to be installed based on information about functions to be used that is included in application installation data.

4. Step S740 of Assessing Security Level

The security level is assessed based on whether the monitoring of the functions included in the application at step S730 determines that the combination of the functions corresponds to a risky function combination.

In the present invention, when an application is installed, functions included in the application to be installed in the mobile terminal 200 are found based on information about functions to be used that is included in the application installation data, and it is determined that the combination of the functions is a risky function combination if the combination of the functions belongs to list B of risky function combinations, such as that shown in FIG. 8. FIG. 8 is a drawing showing list B of cases where the installation of applications is inappropriate in terms of security (abnormal types) and risky function combinations corresponding to the cases.

For example, when the application to be installed is a voice recording application and the combination of the functions of the application corresponds to the combination of a recording function, an Internet function and a Bluetooth function in list B of FIG. 8, the combination of the functions of the application corresponds to a risky function combination and corresponds to the abnormal type “leaking out of photo,” which has been defined in security level 1. Although not shown in the drawings, other risky function combinations are possible, so that the risky function combinations are not limited thereto.

5. Step S750 of Updating List A

When the security level of the application is set based on the assessment of the security level using risky function combinations at step S740, a list corresponding to the set security level is updated to include the application. That is, since the above-described voice recording application was assessed at security level 2 at step S730, list 2 is updated. Then the voice recording application is additionally defined in list 2.

As described above, prior to the installation of an application in the mobile terminal 200, functions included in the application are monitored, a security level is assessed based on whether the combination of the functions corresponds to a risky function combination, and a list corresponding to the set security level is updated to include the application, thereby achieving the effect of applying existing security levels even when a new application is installed.

The methods of implementing mobile terminals 100 and 200 with security functionality according to the present invention may be implemented in the form of program instructions which can be executed using various computer means, and may be recorded in computer-readable media. The computer-readable media may include program instructions, a data file, a data structure, or a combination thereof. The program instructions recorded in the media may be program instructions that are specially designed and constructed for the present invention or that are well known to and used by those skilled in the field of computer software. Examples of the computer-readable media includes magnetic media such as a hard disk, a floppy disk and a magnetic tape, optical media such as CD-ROM and a DVD, magneto-optical media such as a floptical disk, and hardware devices specially configured to store and execute program instructions, such as ROM, RAM and flash memory. Examples of the program instructions include not only machine language code compiled by a compiler but also high-level language code executed by a computer through an interpreter. The above-described hardware device may be configured to operate in the form of at least one software module in order to perform the operation of the present invention, and vice versa.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A mobile terminal with security functionality, comprising:
a storage unit configured to store a list of risky function combinations which have a potential to cause security risks;
a first module configured to monitor functions included in an application to be installed or running in the mobile terminal;
an second module configured to assess security vulnerabilities based on whether a combination of the monitored functions corresponds to a risky function combination and/or security attributes of the mobile terminal; and
a third module for taking countermeasures when a security vulnerability has been found based on the assessment.

2. The mobile terminal of claim 1, wherein:
the first module is configured to find the functions included in the application to be installed based on information about functions to be used that is included in the application installation data when the application is installed; and
the second module is configured to determine whether the combination of the functions included in the application to be installed corresponds to a risky function combination, and assesses the security vulnerability based on results of the determination of whether the combination of the monitored functions corresponds to a risky function combination and/or the security attributes of the mobile terminal.

3. The mobile terminal of claim 1, wherein:
the first module is configured to receive information about running functions from an Operating System (OS) of the mobile terminal; and
the second module is configured to determine whether a combination of the running functions corresponds to a risky function combination, and assess the security vulnerability based on results of the determination of whether the combination of the running functions corresponds to a risky function combination and/or security attributes of the mobile terminal.

4. The mobile terminal of claim 1, wherein the security attributes of the mobile terminal comprise at least one selected from a group consisting of status of permission of administrator authority, information about whether to allow an application which has not been distributed via a market to be installed, and status of locking of the mobile terminal.

5. A mobile terminal with security functionality, comprising:
a storage unit configured to store a list in which one or more applications which are able to run at each security level have been recorded;
a first module for monitoring security status;
an second module for assessing a security level based on information received from the first module and a control module configured to allow only one or more applications included in a corresponding list from running when the security level is set based on the assessment by the second module.

6. The mobile terminal of claim 5, wherein:
the storage unit is configured to store a list of risky function combinations which may cause security risks;
the first module is configured to monitor functions included in an application to be installed in the mobile terminal;
the second module is configured to assess a security level based on whether a combination of the monitored functions corresponds to a function combination that is a security risk; and
the control module that is configured to update a list corresponding to the security level so that the list includes the application when the security level of the application is set based on the assessment.

7. The mobile terminal of claim 5, wherein the first module monitors the security status based on at least one selected from a group consisting of location information of the mobile terminal, time information set in the mobile terminal, and security of an Access Point (AP) to which the mobile terminal makes access.

8. The mobile terminal of claim 5, wherein the control module is configured to output a message that prompts a user to delete an application not included in the corresponding list

9. The mobile terminal of claim 5, wherein the control module is configured to output a message that prompts a user to stop running of an application not included in the corresponding list.

10. The mobile terminal of claim 5, wherein the control module runs a corresponding security solution when the security level is set based on the assessment.

11. A method of implementing a mobile terminal with security functionality, comprising:
storing, by a storage unit, a list of risky function combinations that have a potential to cause security risks;
monitoring, by a first module, functions included in an application to be installed or running in the mobile terminal;
assessing, by a second module, security vulnerabilities based on whether a combination of the monitored functions corresponds to a risky function combination and/or security attributes of the mobile terminal; and
taking, by a third module, countermeasures when a security vulnerability has been found based on the assessment.

12. The method of claim 11, wherein:
monitoring further comprises finding the functions included in the application to be installed based on information about functions to be used that is included in application installation data when the application is installed; and
assessing further comprises determining whether the combination of the functions included in the application to be installed corresponds to a risky function combination, and assessing the security vulnerability based on results of the determination of whether the combination of the monitored functions corresponds to a risky function combination and/or the security attributes of the mobile terminal.

13. The method of claim 11, wherein:
monitoring further comprises receiving information about running functions from an OS of the mobile terminal; and
assessing further comprises determining whether a combination of the running functions corresponds to a risky function combination, and assessing the security vulnerability based on results of the determination of whether the combination of the running functions corresponds to a risky function combination and/or security attributes of the mobile terminal.

14. The method of claim 11, wherein the security attributes of the mobile terminal comprise at least one selected from a group consisting of status of permission of administrator authority, information about whether to allow an application which has not been distributed through a market to be installed, and status of locking of the mobile terminal.

15. A method of implementing a mobile terminal with security functionality, comprising:
storing, by a storage unit, a list in which one or more applications which have the potential to run at each security level have been recorded;
monitoring, by a first module, security status;
assessing, by a second module, a security level based on the monitoring; and
performing, by a control module, control so that only one or more applications included in a corresponding list to run when the security level is set based on the assessment.

16. The method of claim 15, wherein:
storing further comprises storing a list of risky function combinations which may cause security risks;
monitoring further comprises monitoring functions included in an application to be installed in the mobile terminal;
assessing further comprises assesses a security level based on whether a combination of the monitored functions corresponds to a risky function combination; and
performing control further comprises updating a list corresponding to the security level so that the list includes the application when the security level of the application is set based on the assessing.

17. The method of claim 15, wherein monitoring further comprises monitoring the security status based on at least one select from a group consisting of location information of the mobile terminal, time information set in the mobile terminal, and security of an AP to which the mobile terminal makes access.

18. The method of claim 15, wherein performing control further comprises outputting a message prompting a user to either delete an application not included in the corresponding list or to stop running of an application not included in the corresponding list.

19. The method of claim 15, wherein performing control further comprises running a corresponding security solution when the security level is set based on the assessment.

20. A computer-readable recording medium containing executable program instructions executed by a processor that stores a program for executing a method of implementing a mobile terminal with security functionality, comprising:
program instructions that store a list of risky function combinations which have a potential to cause security risks;
program instructions that monitor functions included in an application to be installed or running in the mobile terminal;
program instructions that assess security vulnerabilities based on whether a combination of the monitored functions corresponds to a risky function combination and/or security attributes of the mobile terminal; and
program instructions that take countermeasures when a security vulnerability has been found based on the assessment.
